(19) United States
(12) Patent Application Publication
(10) Pub. No.: US 2014/0236833 A1
(43) Pub. Date: Aug. 21, 2014

(54) TRANSACTION METHOD BASED ON THE GENETIC IDENTITY OF AN INDIVIDUAL AND TOOLS RELATED THEREOF

(71) Applicant: Koen KAS, Schilde (BE)

(72) Inventor: Koen Kas, Schilde (BE)

(21) Appl. No.: 14/349,479

(22) PCT Filed: Oct. 5, 2012
(86) PCT No.: PCT/EP2012/069743

§ 371 Date: Apr. 3, 2014

(30) Foreign Application Priority Data
Oct. 14, 2011 (EP) PCT/EP2011/067987

(51) Int. Cl. G06Q 20/40; G06Q 20/08; G06Q 20/32; G06F 19/24

(52) U.S. Cl. CPC G06Q 20/40145; G06F 19/24; G06Q 20/0855; G06Q 20/3224
USPC 705/44

(57) ABSTRACT

The current invention relates to a method for establishing a transaction between an individual and a third party, based on the genetic identity of an individual, characterized in that said individual allows third party to access and analyze only a subset of said genetic identity, required for the offer and establishment of the transaction. In a second aspect, the invention discloses tools for the analysis of the genetic identity of individuals.

### TECHNICAL FIELD

The invention pertains to a method and tools for the analysis of the genetic identity of an individual, in order to provide individual with a personalized service by a third party or establish a transaction between individual and third party, based on this analysis. In a second aspect, the invention equally discloses a method which allows the individual to independently analyze his genetic identity through the central platform by the provided tools.

### BACKGROUND

Recent efforts in the scientific community, such as the publication of the draft sequence of the human genome in February 2001, have changed the dream of genome exploration into a reality. However, the expensive costs related to genome sequencing as well as the laborious work was long time a huge drawback for any projects and services related to genome exploration. The human genome alone is estimated to have a complexity of 3×10⁹ base pairs, and took roughly 10 years and the collaboration of many labs to complete. Recent improvements in sequencing technology (“next-gen” sequencing platforms) have however sharply reduced the cost of sequencing. The 1000 Genomes Project for instance was the first project to sequence the genomes of a large number of people, to provide a comprehensive resource on human genetic variation. As with other major human genome reference projects, data from the 1000 Genomes Project will be made available quickly to the worldwide scientific community through freely accessible public databases. Another initiative in the genome sequencing field is the thousand dollar genome initiative, whereby the National Institutes of Health (NIH) has awarded over ten million dollars in grant money to companies and institutes aiming to develop tools that will enable sequencing a human genome for $1,000 USD. In 2009, it was announced that IBM was developing a nanopore DNA sequencing technique which will ultimately bring the cost of sequencing the genome of an individual to $100 USD or less.

Apart from the rapid evolution in the field of genome sequencing, other sequencing and data gathering fields, such as the field of transcriptomics and proteomics are equally progressing at a rapid pace, and will soon make it possible to obtain a detailed genetic identity of individuals at a minimal cost. Recently, it is shown how an individual's genetic identity can influence aspects of a person's ancestry, appearance, behavior, and physiology. This has opened the door for a whole range of initiatives whereby personalized services are offered to individuals based on their genetic identity. These initiatives are mainly internet based. The company 23andMe for instance offers a DNA testing service providing information and tools for customers to learn and explore their DNA. A personalized web account provides a secure and easy access to the information of a customer, enabling the customer to explore its genome. Other companies like Navigenics, deCODEme, DNA direct and GeneDx all disclose similar business methods that provide individuals with predictive tests involving genome screening and genetic variation analysis based on single nucleotide polymorphisms (SNPs).

GB 2 363 874 describes a secure bioinformatics-based transaction, whereby a personalized service, such as an insurance policy or a promotional offer is offered based on a bio-informatic value derived from genetic information of a user. The bio-informatic value is computed by a server in a network and stored in a confidential databank allocated to the server.

There remains a need in the art for improving the current business methods, as they often fail in providing adequate security procedures for the access and analysis of the genetic identity of individuals in order to ensure the privacy of the individual, as well as fail to offer a broad scale of possible applications based on the available information stored in the genetic identity. One of the drawbacks and limitations of the current available methods is the lack of adequate summarization of worldwide available genetic information and the limited amount of application domains due to the shortage of adequate queries related thereof, which can be used to mine and analyze genetic identities of individuals. It is the object of the current invention to provide a method which resolves at least some of the problems mentioned above.

### SUMMARY OF THE INVENTION

The present invention provides for a method for establishing a transaction between an individual and a third party, based on the genetic identity of an individual, through a central platform according to claim 1. The method ensures the privacy of the individuals, as they remain the sole owner of their genetic identity since the latter is not kept on an external server. When a third party wishes to provide an individual with an offer for a potential transaction, the individual will only authorize said third party to access and analyze that specific part of its genetic identity which is absolutely required for the establishment of the offer. The remaining information stored in its genetic identity remains shielded and inaccessible for the third party. Furthermore, the method guarantees the availability of a myriad of available queries, which can be used in various application domains, and which are based upon reliable scientific information.

Preferably, the method comprises the following steps:
providing an individual with its genetic identity, whereby said individual stores said genetic identity on a personal storage device;
allowing said individuals to encounter a third party through a central platform;
providing queries to said individuals and/or a third party through said central platform for the analysis of said genetic identity by a third party; whereby said third party, upon outcome of said query, provides said individual with an offer for said transaction;
permitting said individual to accept or decline said offer by third party;
   characterized in that said individual allows third party to access and analyze only a subset of said genetic identity, required for running said query.

In a preferred embodiment, said central platform comprises an application programming interface.

In another preferred embodiment, the individual is allowed to indicate pre-defined preferences prior to receiving said offer for transaction.

In yet another embodiment, third parties and/or individuals will pay remuneration for the use of said queries. More preferably, third parties will also pay remuneration for the use of said genetic identity of individual to the individual.

In a second aspect, the present invention provides for an application programming interface according to claim 9.

In a preferred embodiment, said application programming interface provides individuals with genetic information, based upon a set of pre-defined preferences of said individuals.

In a further preferred embodiment, said queries provided by application programming interface are based upon publicly available data with regards to said genetic information.

### DESCRIPTION OF FIGURES

FIG. 1 depicts a schematic overview of a preferred embodiment of the current invention. The central platform offers tools to an individual and a third party in order to negotiate and agree on a transaction, based on the genetic identity of the individual.

### DETAILED DESCRIPTION OF THE INVENTION

The present invention concerns a method for establishing a transaction between an individual and a third party, based on the genetic identity of the individual.

Unless otherwise defined, all terms used in disclosing the invention, including technical and scientific terms, have the meaning as commonly understood by one of ordinary skill in the art to which this invention belongs. By means of further guidance, term definitions are included to better appreciate the teaching of the present invention.

As used herein, the following terms have the following meanings:

“A”, “an”, and “the” as used herein refers to both singular and plural referents unless the context clearly dictates otherwise. By way of example, “a compartment” refers to one or more than one compartment.

“About” as used herein referring to a measurable value such as a parameter, an amount, a temporal duration, and the like, is meant to encompass variations of +/−20% or less, preferably +/−10% or less, more preferably +/−5% or less, even more preferably +/−1% or less, and still more preferably +/−0.1% or less of and from the specified value, in so far such variations are appropriate to perform in the disclosed invention. However, it is to be understood that the value to which the modifier “about” refers is itself also specifically disclosed.

“Comprise,” “comprising,” and “comprises” and “comprised of” as used herein are synonymous with “include”, “including”, “includes” or “contain”, “containing”, “contains” and are inclusive or open-ended terms that specifies the presence of what follows e.g. component and do not exclude or preclude the presence of additional, non-recited components, features, element, members, steps, known in the art or disclosed therein.

The recitation of numerical ranges by endpoints includes all numbers and fractions subsumed within that range, as well as the recited endpoints.

The expression “% by weight” (weight percent), here and throughout the description unless otherwise defined, refers to the relative weight of the respective component based on the overall weight of the formulation.

In a first aspect, the invention provides a method for establishing a transaction between an individual and a third party, based on the genetic identity of an individual, comprising the steps of:
providing an individual with its genetic identity, whereby said individual stores said genetic identity on a personal storage device;
allowing said individuals to encounter a third party through a central platform;
providing queries to said third party through said central platform for the analysis of said genetic identity by a third party; whereby said third party, upon outcome of said query, provides said individual with an offer for said transaction;
permitting said individual to accept or refuse said offer by third party;
   characterized in that said individual allows third party to access and analyse only a subset of said genetic identity, required for running said query.

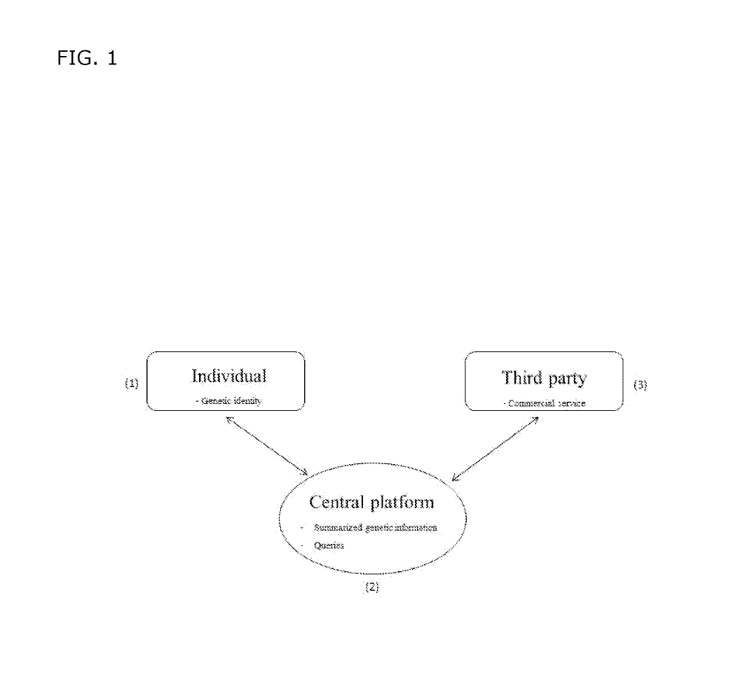

FIG. 1 schematically depicts the preferred embodiment of the current invention, whereby an individual (1), owner of his genetic identity, can come into contact with a third party (3) in order to negotiate and establish a transaction based on this genetic identity, through a central platform (2). The central platform (2) can provide both the individual (1) and the third party (3) with the tools and information for the analysis of the genetic identity in the desired field or for the preferred application.

As used herein, the term genetic identity is to be understood as the sum of the genetic information that may be acquired from and which uniquely relates to an individual. This genetic information may include all genomic, epigenomic, transcriptomic, proteomic and/or metabolic information from the individual.

As used herein, the term individual is to be understood as any person or entity capable of providing a biological sample which can be analysed in order to acquire its genetic identity. The term biological sample may comprise genomic, epigenomic, transcriptomic, proteomic, and/or metabolic information of the subject. Examples of biological samples include but are not limited to blood, DNA, RNA, urine, serum, hair, smears, cells and the like.

The term third party is any third person, or party, which is able to offer or deliver a service, transaction, agreement, advice, promotion, etc. in relation to the analysis of the genetic identity and genetic profile of an individual. Examples of third parties are for instance doctors and other professionals in the health services, pharmacists, sport instructors, fitness schools and insurance companies. It should be obvious to a person skilled in the art that the latter are merely examples of potential third parties and do not limit the scope of current invention.

For the purpose of the present invention the genomic information of an individual is to be understood as comprising partial or full genome sequences from said individual, being DNA or RNA, as well for instance sequences of mitochondrial DNA, or merely SNPs.

For the purpose of the present invention the epigenomic information of an individual is to be understood as comprising data on the chromatin structure of cells and/or tissues of said individual as well as on the presence of epigenetic mechanisms such as DNA methylation and modifications to histone proteins.

For the purpose of the present invention the transcriptomic information of an individual is to be understood as comprising data on the pool of RNA present in cells and/or tissues of an individual, the term pool of RNA comprising mRNA, tRNA, rRNA and other non-coding RNA.

For the purpose of the present invention the proteomic information of an individual is to be understood as comprising data on the protein or peptide expression profiles of said individual, as well for instance data on post-translational modifications (such as phosphorylation, glycosylation, ubiquitination, methylation, acetylation, glycosylation, oxidation, nitrosylation).

For the purpose of the present invention, the metabolic information is to be understood as comprising data on metabolites present in for instance specific cells or tissues of said individual.

It is to be understood that the genetic identity of an individual may be acquired through conventional techniques and methodologies which are well-known to any person skilled in the art.

For the purpose of the present invention, the term central platform is to be understood as a central place or point which allows two parties to meet and offer, negotiate, establish and close transactions.

The transactions may take numerous forms and will depend on the nature and the services provided by the third parties. These transactions and services may include, but are not limited to insurance policy offers, promotional offers, dietary advice, sport advice, health and disease diagnostics and/or information, information on specific features (e.g. trait, phenotype, drug response), risk calculation and hereditary information. It should be clear to a person skilled in the art that a wide range of transactions and services are applicable to current invention.

The invention can be implemented in numerous ways, including as a process; an apparatus; a system; a composition of matter; a computer program product embodied on a computer readable storage medium, e.g. a mobile device such as a cell phone; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

In one embodiment, an individual will receive his genetic identity after analysis of the biological samples required to establish the genetic identity. In a preferred embodiment, said individual will be the sole holder of all data regarding his genetic identity. In a more preferred embodiment, said genetic identity will be preserved and stored by the individual on a personal storage device. Such personal storage devices are to be understood as any storage device known to a person skilled in the art which can contain data sets, preferably secured by a password and the like, and may include but are not limited to a hard disk, a chip card, a smart card, an RFID, a memory stick, a smartphone or proprietary cloud storage products and services. In another preferred embodiment, the individual data is stored in the cloud using simple web-based protocols.

When having obtained and stored his genetic identity, the individual can encounter a third party in order to establish a transaction between said individual and third party. In one embodiment, said encounter between individual and third party might occur spontaneous and ad random. In another embodiment, said encounter might occur upon specific request of said individual, who wishes to explore whether information regarding a specific desire or feature can be received and whether particular decisions can depend on said specific desire or feature. In another embodiment, said encounter might occur upon a specific request of a third party to said individual for querying the genetic identity. In yet another embodiment, said individual is allowed to indicate pre-defined preferences prior to encountering a third party and receiving an offer for a transaction. These pre-defined preferences might for instance relate to personal interests of said individual, such as hobbies, health issues, sports, etc., as well as specific interests in commercial offers and services provided by third parties. Hence, only third parties that deliver any service or transaction which are related to said predefined preferences of said individual are allowed to contact and encounter said individual. In another embodiment, the encounter between individual and third party might occur upon request of said third party, and after approval of said individual.

The method of the current invention provides means for achieving a real-time encounter and possible transaction between individual and third party on the basis of the GPS location of the device which runs the application (e.g. mobile phone) and which belongs to said individual. For instance, an individual in search of a specific transaction may rely on the GPS tracking of his mobile phone running the application to find the nearest by third parties which offer such transaction. Said individual can indicate the specific type of interaction he's interested in, after which an application filters out the third parties which provide a matching service, taking into account the location of said individual.

Encounter and establishment of a transaction between different parties (on one side the individual, on the other side the third party offering a commercial service) occurs preferably through a central platform. Said central platform is governed by an external party, which is independent from said individuals and third parties. This external party or governor is to be seen as a broker or facilitator, which arranges transactions between the individual and a third party, by providing the essential means to come to a transaction. Preferably, said governor gets a commission when a transaction is executed.

In a preferred embodiment, said central platform comprises an application programming interface (API) and a user interface. Queries are provided through said central platform to individuals and/or third parties which allow for the analysis of the genetic identity of said individual. Said queries are to be understood as any algorithm, application, tool, website, RFID which is able and allowed to mine a part of said genetic identity of an individual, in order to extract specific information which eventually might lead to an offer, or transaction. More specifically, said queries are related to specific fields, interests, preferences, data, etc. which can be applied to mine and extract specific information related to the genetic identity of an individual. For instance, queries might be launched which search for the presence of a certain gene, single nuclear polymorphism (SNP), transcribed RNA or expressed protein which is known to be related to the development of a disease. Other example of queries might for instance be related to hereditary information, or susceptibility to a certain product, or compound. In general, numerous queries can be developed to mine said genetic identity based upon all information available to the public. More specifically, the set of provided queries through the central platform is not to be seen as a static, but rather as dynamic set, as it expands upon the release and discovery of novel information in relation to the genetic identity of an individual.

In one embodiment, the queries may be developed based upon available or private data and provided to the central platform by external persons or parties. More preferably, the available set of queries is developed and controlled by the governor of the central platform. As such, the governor serves as a gate-keeper for the assurance of the quality said provided set of queries. In order to keep up-to-date with the available public information which might be used for the development of said set of queries, said governor of the central platform will closely watch, gather and implement public information provided by for instance the scientific community in operational queries for the analysis of genetic identities.

Preferably, said individual will be informed on all queries available and on newly developed queries. Said individual will equally be presented with possible third parties who can provide a transaction based on said query. More preferably, said individual will specifically be presented by these third parties which are located within a specific perimeter of said individual. Location information of the individual is preferably retrieved through GPS localisation of the device running said api. The desired perimeter is variable, and can be pre-set by the individual.

After agreeing to the analysis of its genetic identity by a third party, said third party will only gain access to and be able to analyse a subset of said genetic identity of the individual. The latter ensures the privacy and confidentiality of the individual in relation to information stored in his genetic identity which he wishes to keep private. In a preferred embodiment, said genetic identity is encrypted by an algorithm, whereby encryption securely protects said genetic identity to be accessed and read by a third-party. Only upon approval of said individual, a third party will gain access to subset of said genetic identity, by decryption of said subset. Said subset of the genetic identity is to be understood as this particular data or information set from said genetic identity which is related to the envisioned transaction and which is essential for launching a query, whereby the outcome of said query is decisive for the provision of an offer for a transaction to an individual. The required subset is defined by the query to be launched. Said subset may for instance be a gene sequence, a SNP, genomic loci, a chromosome, an expression profile of a certain protein, an expressed sequence tag, a metabolite, etc. The remaining information stored in the genetic identity of the individual remains shielded and inaccessible for the third party. It is to be understood that the techniques and algorithms for encrypting a data set and decrypting a subset thereof for particular use and application are known to a person skilled in the art.

Upon receiving the offer with regards to a potential transaction between an individual and a third party, said individual is allowed to accept or decline said offer.

As mentioned previously, in a preferred embodiment, the individual may indicate a set of pre-defined preferences, which reflect his interests in various domains of potential services or transactions offered by third parties. Only third parties offering services related to these preferences may come into contact with the individual to establish a transaction through the central platform, preferably being an API. In a more preferred embodiment, these said preferences may equally be used by the central platform and the governor thereof to inform the individual and/or third party on genetic and/or scientific information which has become publicly available and which relates to their indicated preferences. The term genetic information is to be understood as all information related to genomics, proteomics, epigenomics, transcriptomics, metabolomics and biochemistry which can be associated to a certain phenotype, disease development, health risk, psychological and/or social behaviour of an individual. In another embodiment, the said third parties are equally allowed to indicate a set of predefined preferences, in order to receive updates on the available genetic information and queries related to the domain of field of their provided services. Information about new genetic information emerging from the most current research may be send periodically. Information may be send or ‘pushed’ through an online journal, magazine, E-mail, internet protocol, alerting service, and/or through post to the subscriber.

In further embodiment of the invention, said governor suggests and allows an individual to launch queries through the central platform for the analysis of its own genetic identity, preferably with regards to the predefined preferences of said individual.

Preferably, said both the individual and third parties will have to pay remuneration to the governor for using the provided queries through the central platform. Furthermore, third parties may equally have to remunerate the individual for allowing the access to its genetic identity. In another preferred embodiment, third party will remunerate said governor when a transaction is established and agreed on.

In a second aspect, the invention relates to an application programming interface (API) which provides individuals and third parties with queries to analyse and mine the genetic identity of said individuals.

The invention is further described by the following non-limiting examples which further illustrate the invention, and are not intended to, nor should they be interpreted to, limit the scope of the invention.

### EXAMPLES

### Example 1

In the case the individual is a patient, and the third party a medical doctor, the medical doctor might benefit from gathering as much relevant information of his patients as possible. For instance, an analysis of his patient for his susceptibility of developing common genetically linked diseases like breast cancer or Parkinson disease will help to optimize and personalize the health care service provided by a doctor to a patient. When a doctor is aware that his patient is prone to developing disease A or B, he will likely adjust his care given to a patient, such as screening for early symptoms related to these diseases allowing him to identify these at an early phase. By use of the queries provided by the central platform, utilizing the most current knowledge related to for instance mutations or structural variations in/near genes that are associated with the demanded information (e.g. for breast cancer, screening for BRCA1 & BRCA2, and for treatment of metastatic melanoma patients with Zelboraf (vemurafenib) screening for mutations at position 600 in the oncogene B-RAF), the doctor agent may gain better knowledge of his patient's predisposition to certain diseases or conditions or his patient's likelihood to respond to certain drugs. The launched queries through the central platform may for instance also be related to the susceptibility or potential allergies to substances such as medications or drugs. All this information will lead to a better and optimal personalized health care.

### Example 2

In the case the individual is a consumer, and the third party a food provider (Nestle, Danone . . . ), the food provider might benefit from gathering specific information of this individual/consumer. For instance, an analysis of this individual for his susceptibility of tasting cilantro as a fresh spice rather than as soap, might make the individual amenable to be part of a test panel for a novel pre-prepared meal containing cilantro.

This way the food provider could recruit/invite the individual based on its specific ‘predisposition’ of cilantro taste.

1. A method for establishing a transaction between an individual and a third party, based on the genetic identity of an individual, comprising the steps of:
providing an individual with its genetic identity, whereby said individual stores said genetic identity on a personal storage device;
allowing said individuals to encounter a third party through a central platform;
providing queries to said individuals and/or said a third party for the analysis of said genetic identity by said a third party; whereby said third party, upon outcome of said query, provides said individual with an offer for said transaction;
permitting said individual to accept or decline said offer by said third party;
wherein said individual allows said third party to access and analyse only a subset of said genetic identity stored on said personal storage device, required for running said query whereby said query is provided through said central platform and whereby said central platform is governed by a governor.

2. A method according to claim 1, whereby said central platform comprises an application programming interface.

3. A method according to claim 1, wherein said encounter occurs upon request of said third party.

4. A method according to claim 1, wherein said encounter occurs upon request of said individual.

5. A method according to claim 1, said individual indicating pre-defined preferences prior to receiving said offer for transaction.

6. A method according to claim 1, whereby said third party will pay remuneration for the use of said queries to said governor.

7. A method according to claim 1, whereby said third party will pay remuneration for the use of said genetic identity of individual to the individual.

8. A method according to claim 1, wherein said encounter and/or transaction between an individual and third party depends on the location of said individual.

9. An application programming interface part of a central platform governed by a governor which provides individuals and/or third parties with queries to analyse and mine the genetic identity of said individuals.

10. An application programming interface according to claim 9 which provides individuals with genetic information, based upon a set of pre-defined preferences of said individuals.

11. An application programming interface according to claim 10, whereby said queries are based upon publicly available data with regards to said genetic information.

12. A method according to claim 2, wherein said encounter occurs upon request of said third party.

13. A method according to claim 2, wherein said encounter occurs upon request of said individual.

14. A method according to claim 2, said individual indicating pre-defined preferences prior to receiving said offer for transaction.

15. A method according to claim 2, whereby said third party will pay remuneration for the use of said queries to said governor.

16. A method according to claim 2, whereby said third party will pay remuneration for the use of said genetic identity of individual to the individual.

17. A method according to claim 2, wherein said encounter and/or transaction between an individual and third party depends on the location of said individual.
